(19) United States
(12) Patent Application Publication
(10) Pub. No.: US 2026/0238378 A1
(43) Pub. Date: Aug. 13, 2026

(54) CAPABILITY REPORTING METHOD, DEVICE AND STORAGE MEDIUM

(71) Applicant: BEIJING XIAOMI MOBILE SOFTWARE CO., LTD., Beijing (CN)

(72) Inventor: Juan ZHANG, Beijing (CN)

(21) Appl. No.: 19/153,519

(22) PCT Filed: Feb. 7, 2023
(86) PCT No.: PCT/CN2023/074839

§ 371 Date: Aug. 4, 2025

(51) Int. Cl. H04L 1/00; H04L 5/00

(52) U.S. Cl. CPC H04L 1/0003; H04L 5/0098

(57) ABSTRACT

A device and/or a storage medium implement(s) a capability reporting method. The capability reporting method can be applied to a terminal. The method comprises: sending capability information of the terminal to a network device, wherein the capability information is used for indicating modulation and coding scheme (MCS) index values supported by the terminal on one or more frequency bands, and the MCS index values comprise some or all of MCS index values in one or more MCS index tables.

### CROSS-REFERENCE TO RELATED APPLICATIONS

This application is a U.S. national stage application of International Application No. PCT/CN2023/074839, filed Feb. 7, 2023, the entire content of which is incorporated herein by reference.

### TECHNICAL FIELD

The present disclosure generally relates to the field of a communication technology, and more particularly, to a capability reporting method, device and storage medium.

### BACKGROUND

Some terminals do not support all modulation and coding scheme (MCS) indices under their supported modulation modes. However, in the related art, some terminals can only report a modulation mode supported by these terminals to a network device without an MCS index supported by these terminals. As a result, these terminals fail to achieve an expected gain for some index values.

### SUMMARY

According to a first aspect of embodiments of the present disclosure, there is provided a capability reporting method, applied to a terminal, and including:

transmitting capability information of the terminal to a network device, wherein the capability information indicates a modulation and coding scheme (MCS) index value supported by the terminal on one or more frequency bands, and the MCS index value comprises some or all MCS index values in one or more MCS index tables.

According to a second aspect of embodiments of the present disclosure, there is provided a capability reporting method, applied to a network device, and including:
receiving capability information of a terminal transmitted from the terminal, wherein the capability information indicates a modulation and coding scheme (MCS) index value supported by the terminal on one or more frequency bands, and the MCS index value comprises some or all MCS index values in one or more MCS index tables.

According to embodiments of the present disclosure, there is provided a communication apparatus, including a processor; and a memory for storing instructions executable by the processor, in which the processor is configured to perform a step of the method as described in any one of the first aspect of embodiments of the present disclosure; or the processor is configured to perform a step of the method as described in any one of the second aspect of embodiments of the present disclosure.

According to embodiments of the present disclosure, there is provided a non-transitory computer-readable storage medium having stored thereon a computer program instruction that, when executed by a processor to implement a step of the method as described in any one of the first aspect of embodiments of the present disclosure, or that, when executed by a processor to implement a step of the method as described in any one of the second aspect of embodiments of the present disclosure.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a communication system according to an illustrative embodiment.

FIG. 2 is a flow chart illustrating a capability reporting method according to an illustrative embodiment.

FIG. 3 is a flow chart illustrating a capability reporting method according to an illustrative embodiment.

FIG. 4 is a flow chart illustrating a capability reporting method according to an illustrative embodiment.

FIG. 5 is a flow chart illustrating a capability reporting method according to an illustrative embodiment.

FIG. 6 is a flow chart illustrating a capability reporting method according to an illustrative embodiment.

FIG. 7 is a flow chart illustrating a capability reporting method according to an illustrative embodiment.

FIG. 8 is an interaction diagram illustrating a capability reporting method according to an illustrative embodiment.

FIG. 9 is a block diagram illustrating a terminal according to an illustrative embodiment.

FIG. 10 is a block diagram illustrating a network device according to an illustrative embodiment.

FIG. 11 is a block diagram illustrating a communication apparatus according to an illustrative embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. Instead, they are merely examples of apparatuses and methods consistent with aspects related to the present disclosure as recited in the appended claims.

In the description of the present disclosure, terms such as “first,” “second,” and the like are used to distinguish similar objects and should not be construed as indicating a specific order or sequence. Furthermore, unless otherwise stated, in the description referring to the accompanying drawings, the same reference numerals in different drawings represent the same elements.

In the description of the present disclosure, unless otherwise stated, “a plurality of” refers to two or more than two, with other quantifiers following the same principle. “at least one”, “one or more”, or similar expressions refers to any combination of the listed element(s), including a single element, or any combination of plural elements. For example, “at least one” may represent any quantity. As another example, “one or more of a, b, and c” may represent: a, b, c, a-b, a-c, b-c, or a-b-c, where a, b, and c may each be singular or plural. “and/or” describes an association relationship between related objects, indicating that three relationships may exist. For example, “A and/or B” may refer to: A alone, both A and B, and B alone, where A and B may each be singular or plural.

In embodiments of the present disclosure, although operations or steps are described in a specific order in the accompanying drawings, it should not be construed as requiring that such operations or steps be performed in the particular order shown or in sequential order, or that all illustrated operations or steps be performed to achieve desired results. In embodiments of the present disclosure, these operations or steps may be performed in any order; they may also be executed in parallel; or only a portion of these operations or steps may be performed.

The implementation environment of embodiments of the present disclosure will first be introduced below.

The technical solutions described in embodiments of the present disclosure can be applied to various communication systems. These communication systems may include one or more of the 4th generation (4G) communication system, the 5th generation (5G) communication system, and other future wireless communication systems (e.g., 6G). The communication system may also comprise one or more of a public land mobile network (PLMN) system, a device-to-device (D2D) communication system, a machine-to-machine (M2M) communication system, an internet of things (IoT) communication system, a vehicle-to-everything (V2X) communication system, or other communication systems.

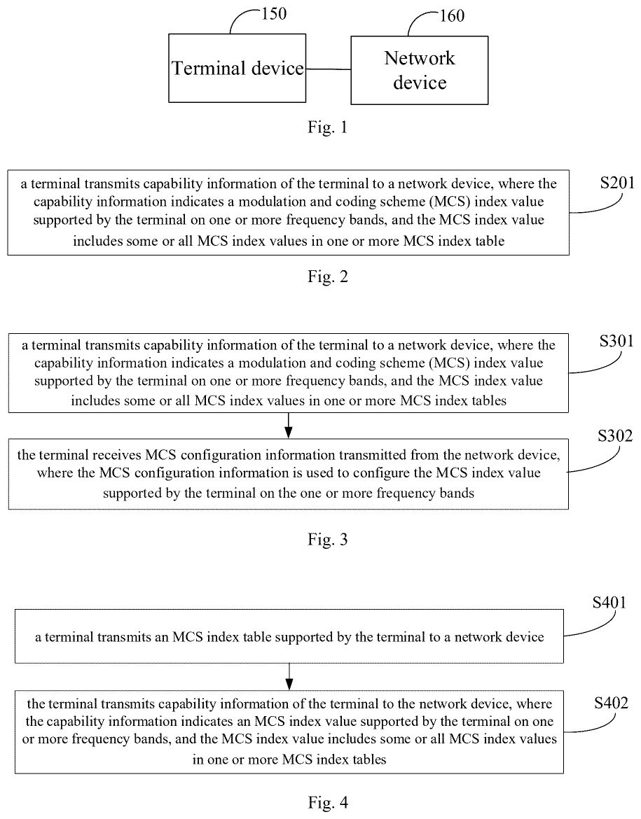

FIG. 1 is a schematic diagram illustrating a communication system according to an illustrative embodiment. As shown in FIG. 1, the communication system may include a terminal device 150 and a network device 160. The communication system can be used to support the 4G network access technology, such as the long term evolution (LTE) access technology; or the 5G network access technology, such as new radio access technology (New RAT); or other future wireless communication technologies. It should be noted that in the communication system, the number of the network devices may be one or more, and the number of the terminal devices may also be one or more. The number of the network devices and the number of the terminal devices in the communication system, as shown in FIG. 1, are merely illustrative examples, which are not limited in the present disclosure.

In FIG. 1, the terminal device 150 may also be referred to as a user equipment (UE), a subscriber unit, a mobile station, a station, a terminal, etc. As an example, the terminal device may include a smart phone, a smart wearable device, a smart speaker, a smart tablet, a wireless modem, a wireless local loop (WLL) station, a personal digital assistant (PDA), or a customer premise equipment (CPE), and the like. With the development of the wireless communication technology, a device that can access a communication system, can communicate with a network device in the communication system, or can communicate with other objects through the communication system; or a device that enables direct communication between two or more devices, may be the terminal device in embodiments of the present disclosure, for example, a terminal and a vehicle in a smart transportation system, a household appliance in a smart home, a power meter reading instrument in a smart grid, a voltage monitoring device, an environmental monitoring instrument, a video surveillance device in a smart security network, a point-of-sale terminal, etc. In embodiments of the present disclosure, the terminal device can communicate with the network device; multiple terminal devices can communicate with each other; the terminal device can be either stationary or mobile, which are not limited in the present disclosure.

In some embodiments, the network device 160 as shown in FIG. 1 may include a device that supports access of the terminal device and provides wireless network communication functionality for the terminal device. In some embodiments of the present disclosure, the network device may include an access network device and/or a core network device. The access network device may be a radio access network (RAN) or an access network (AN). As an example, the access network device may be an evolutional base station (evolutional Node B, eNB or eNodeB) in a long term evolution (LTE) system; the access network device may also be a next generation base station (next Generation Node B, gNB or gNodeB) in the 5G network; the access network device may also be a radio access network (NG Radio Access Network, NG-RAN) in the 5G network; the access network device may also be a base station in a future evolved public land mobile networks (PLMN), a broadband network gateways (BNG), an aggregation switch or non-3rd generation partnership project (3GPP) access device, etc. Optionally, in embodiments of the present disclosure, the access network device may include various forms of base stations, for example, a macro base station, a micro base stations (also referred to as a small station), a relay station, an access point, a 5G base station or a future base station, a satellite, a transmission and reception points (TRP), a transmission points (TP), a mobile switching center and a device that functions as a base station in device-to-device (D2D), machine-to-machine (M2M), internet of thing (IoT), vehicle-to-everything (V2X) or other communications, which is not specifically limited in the present disclosure. For convenience of description, in embodiments of the present disclosure, the device providing the wireless communication functionality for the terminal device are collectively referred to as the access network device or the base station. The core network device may be used to perform one or more of the following functionalities for the terminal device: mobility management, call control, session management, registration and authentication, billing, or the like. The core network device may include one or more entities, where each entity may be a hardware, a functionality-based software, or a structure combining the two above. It should be noted that such an entity may alternatively be referred to as a function.

The following provides further details regarding the relevant technology.

In the related art, configuration of a communication rate of a terminal is implemented through a modulation and coding scheme (MCS) index value. The MCS organizes a factor of concern that affects the communication rate as a column in a table, with an MCS index as a row, thereby forming a rate table known as an index table. The MCS defines the number of valid bits that can be carried by one resource element (RE, resource element 1). There are 32 MCSs in total, denoted as 0 to 31, with 29 to 31 reserved. The higher the MCS index is, the greater number of the valid bits can be carried. Which specific MCS is selected depends on a quality of a wireless link. The better the quality is, the higher MCS is, the great number of valid bits that can be transmitted per symbol, while a poor signal quality only allows for selection of a low MCS index, meaning reduced valid data that can be transmitted per symbol. In specific, the network device may select MCS according to a block error rate (BLER). The network device may allocate MCS using a link adaptation algorithm, thereby maintaining the BLER below a threshold across varying radio conditions.

Further, in the related art, for a physical uplink shared channel (PUSCH), the terminal is provided with three index tables to make a selection: a 64 quadrature amplitude modulation (QAM) table, a 256QAM table, and a low spectral efficiency 64QAM table. In specific, the 64QAM index table may be used, when the network device or the terminal does not support 256QAM or is of a poor channel, decoding is unsuccessful with the 256QAM table, and the network device requires to use quadrature phase shift keying (QPSK) order modulation; the 256QAM table may be used, when the channel is in a good state, and the device supports 256QAM; the low spectral efficiency 64QAM table is applicable to an application requiring reliable data transmission, e.g., ultra-reliable low-latency communication (URLLC)-based application, MCS improves channel reliability by a reduced coding rate, enhanced channel coding redundancy, thus resulting in low spectral efficiency.

The network device may determine a specific MCS index table and a specific MCS index the terminal uses, based on the link adaptation algorithm. For example, the network device may indicate the MCS index table to the terminal via a radio resource control (RRC) signaling. After indicating the index table, the network device may provide selected MCS configuration information to the terminal via downlink control information (DCI).

Some terminals do not support all modulation and coding scheme (MCS) indices under their supported modulation modes. However, in the related art, some terminals can only report a modulation mode supported by these terminals to a network device without an MCS index supported by these terminals. As a result, these terminals fail to achieve an expected gain for some index values.

As an example, in the related art, when a terminal reports through an information element PUSCH-256QAM that the terminal supports 256QAM, it indicates that the terminal supports all MCS indices corresponding to 256QAM modulation. However, in Frequency range 2 (FR2), when the terminal supports UL256QAM, it is found by link simulation that for a high MCS index, 256QAM cannot achieve the expected gain compared to UL 64QAM.

In view of this, in one embodiment, the network device in the communication system as shown in FIG. 1 may be a base station, the terminal device may be a terminal, the base station may be used to perform a step of the capability reporting method executed at the network device side as described in the following embodiments, and the terminal may be used to perform a step of the capability reporting method executed at the terminal side as described in the following embodiments, so that the terminal can report the MCS index value supported by the terminal, and so that the base station can perform MCS configuration of the terminal more accurately, and so that the terminal can perform modulation based on the MCS index value supported by the terminal.

In one specific embodiment, when the terminal reports to the network device, e.g., the base station, the modulation mode supported by the terminal, the MCS index value supported by the terminal may be reported per band.

In one possible implementation, in a case that the terminal cannot achieve the expected gain using the high MCS index value in the 256QAM index table in FR2, when the terminal reports through the existing information element PUSCH-256QAM that the terminal supports UL 256QAM, the terminal may further indicate through a new information element specific MCS indices supported by the terminal in the 256QAM index table, specifically may indicate specific indices values supported by the terminal in the MCS indices 20 to 27.

In another possible implementation, to facilitate extension of this reporting capability for other existing high-order modulation modes, the new information element can also be defined as an enumeration signaling that reports the index value corresponding to one modulation mode supported by the terminal at a time. The new information element may correspond to any one of 256QAM, 64QAM, and low spectral efficiency 64QAM. The terminal can determine, by selecting a parameter in the information element, a specific modulation mode the new information element specifically corresponds to.

Further, if the above new information element is absent and not reported, it indicates that the terminal supports all MCS index values in the corresponding MCS index table.

In addition, the MCS index allocated by the network device using the link adaptation algorithm may be within an index range reported by the terminal. In other words, the MCS index value indicated by the MCS configuration information transmitted from the network device to the terminal may be determined based on the MCS index value belonging to those reported by the terminal.

In view of the above overall inventive concept, the present disclosure further provides the following embodiments.

In order to solve the problems in the related art, the present disclosure provides in embodiments a capability reporting method, device and storage medium.

According to a first aspect of embodiments of the present disclosure, there is provided a capability reporting method, applied to a terminal, and including:

transmitting capability information of the terminal to a network device, wherein the capability information indicates a modulation and coding scheme (MCS) index value supported by the terminal on one or more frequency bands, and the MCS index value comprises some or all MCS index values in one or more MCS index tables.

According to a second aspect of embodiments of the present disclosure, there is provided a capability reporting method, applied to a network device, and including:
receiving capability information of a terminal transmitted from the terminal, wherein the capability information indicates a modulation and coding scheme (MCS) index value supported by the terminal on one or more frequency bands, and the MCS index value comprises some or all MCS index values in one or more MCS index tables.

According to a third aspect of embodiments of the present disclosure, there is provided a terminal, including
a transmitting module, configured to transmit capability information of the terminal to a network device, wherein the capability information indicates a modulation and coding scheme (MCS) index value supported by the terminal on one or more frequency bands, and the MCS index value comprises some or all MCS index values in one or more MCS index tables.

According to a fourth aspect of embodiments of the present disclosure, there is provided a network device, including:
a receiving module, configured to receive capability information of a terminal transmitted from the terminal, wherein the capability information indicates a modulation and coding scheme (MCS) index value supported by the terminal on one or more frequency bands, and the MCS index value comprises some or all MCS index values in one or more MCS index tables.

According to a fifth aspect of embodiments of the present disclosure, there is provided a communication system, including:
a terminal, configured to perform the method as described in any one of the first aspect of embodiments of the present disclosure; and
a network device, configured to perform the method as described in any one of the second aspect of embodiments of the present disclosure.

According to a sixth aspect of embodiments of the present disclosure, there is provided a communication apparatus, including a processor; and a memory for storing instructions executable by the processor, in which the processor is configured to perform a step of the method as described in any one of the first aspect of embodiments of the present disclosure; or the processor is configured to perform a step of the method as described in any one of the second aspect of embodiments of the present disclosure.

According to a seventh aspect of embodiments of the present disclosure, there is provided a computer-readable storage medium having stored thereon a computer program instruction that, when executed by a processor to implement a step of the method as described in any one of the first aspect of embodiments of the present disclosure, or that, when executed by a processor to implement a step of the method as described in any one of the second aspect of embodiments of the present disclosure.

The technical solutions provided in embodiments of the present disclosure may have following advantageous effects. The terminal can, by transmitting the capability information that indicates the MCS index value supported by the terminal, where the MCS index value indicated by the capability information may only include the index value supported by the terminal, report the terminal capability more accurately, thereby avoiding that the terminal cannot achieve the expected gain for some index values corresponding to the modulation mode the terminal supports, thereby ensuring transmission reliability.

FIG. 2 is a flow chart illustrating a capability reporting method according to an illustrative embodiment. The method is applied to a terminal, as shown in FIG. 2, the method include S201.

At S201, the terminal transmits capability information of the terminal to a network device, where the capability information indicates a modulation and coding scheme (MCS) index value supported by the terminal on one or more frequency bands, and the MCS index value includes some or all MCS index values in one or more MCS index table.

In specific, the capability information may be carried by a physical uplink shared channel (PUSCH) or may be carried by other uplink signals. In some possible implementations, the capability information may further include other information indicating other capabilities of the terminal, for example, may include a current load of the terminal, a processing capability of its own, and the MCS index table supported by the terminal, etc., which is not specifically limited by the present disclosure. In addition, the capability information indicating the MCS index value supported by the terminal on one or more frequency bands may be the above-described capability information, or may also be any other information, such as uplink control information (UCI) or the like, which is not limited by the present disclosure.

It should be noted that the MCS index value supported by the terminal may refer to the MCS index value that allows the terminal to achieve the expected gain, or refer to the MCS index value that allows the gain to meet a preset condition. As an example, some MCS index values that are not included in the capability information may be MCS index values that are not supported by the terminal.

In addition, the MCS index value may also be described as an MCS index or an MCS value, while the MCS index table may also be described as an MCS table or an MCS sheet, etc., which are not limited in the present disclosure.

In one embodiment, the MCS index table supported by the terminal specifically may refer to the MCS index table supported by the terminal on one or more frequency bands corresponding to the capability information. Optionally, if the terminal supports a certain MCS index table, it indicates that the terminal supports a modulation mode corresponding to this index table, and vice versa.

In one example, the MCS index value indicated by the capability information includes some or all MCS index values in the MCS index table supported by the terminal.

As an example, after determining that the terminal supports a certain MCS index table on a certain frequency band, the terminal may determine, according to its own capability, a wireless link quality or the like, an index value with a good gain in the MCS index table supported by the terminal, and indicates through the capability information these index values to the network device.

As another example, in a case that the capability information includes an MCS index value corresponding to an MCS index table that is not supported by the terminal, after receiving the capability information, the network device may further discard or ignore these index values in the capability information. For example, in a case that the network device determines according to the information previously reported by the terminal device that the terminal does not support the 256QAM index table, even if the network device receives an index value corresponding to 256QAM, the network device may discard or ignore these index value.

In one embodiment, the capability information specifically may indicate an index value supported by the terminal on each frequency band, or may indicate an index value supported by the terminal on a certain frequency band. Accordingly, the MCS index value supported by the terminal may be an MCS index value supported by the terminal on each frequency band, or may be an MCS index value supported by the terminal on a certain frequency band. In one embodiment, by transmitting the capability information multiple times, the terminal may also indicate the MCS index value supported by the terminal on each frequency band. In some embodiments, the MCS index value may be represented as IMcs, the index value may range from 0 to 31, in one same index table, the higher the index value is, the more valid bits can be transmitted in one symbol, i.e., the higher the signal quality is, where 29 to 31 may be reservation indices. In some embodiments, specific index values the terminal supports may be determined according to the terminal's capability, the network device's capability, and/or the wireless link's quality. For example, if the terminal does not support an MCS index 26 in the 256QAM index table, the MCS index value indicated by the capability information may not include the MCS index 26.

In one example, the MCS index table supported by the terminal includes one or more of a 256QAM index table, a 64QAM index table, and a low spectral efficiency 64QAM index table.

In some embodiments, specific index tables the terminal supports may be determined according to the terminal's capability, the network device's capability, and/or the wireless link's quality. Further, in addition to the above index tables, the MCS index table supported by the terminal may include a 2048QAM index table in a case that other index tables are further defined or the terminal and the network device are further improved with the technology development, e.g., the terminal and the network device can support a 2048QAM modulation mode, accordingly, the MCS index value indicated by the capability information may further include an index value in the 2048QAM index table.

In one example, the capability information further indicates the MCS index table supported by the terminal.

Alternatively, in another example, prior to transmitting the capability information of the terminal to the network device, the method further includes:
transmitting the MCS index table supported by the terminal to the network device.

With respect to detailed contents for the step of transmitting the MCS index table supported by the terminal to the network device, detailed description corresponding to the step S401 as shown in FIG. 4 may be referred to, which will not be repeated here.

As an example, a specific MCS index table the terminal supports may be reported to the network device by transmission through other signaling or information elements, or may be reported to the network device through the capability information. In other words, in a case that the terminal determines that the terminal supports a certain MCS index table, the terminal may transmit in advance, prior to transmitting the capability information, the information that indicates the MCS index table supported by the terminal; alternatively, the terminal may further transmit the information that indicates the MCS index table supported by the terminal and that is carried by the capability information.

For example, the capability information specifically may further indicate the MCS index table supported by the terminal and the MCS index value corresponding to the MCS index table supported by the terminal. In specific, the information element that indicates the MCS index table supported by the terminal may be different from the information element that indicates the MCS index value supported by the terminal.

As an example, in the related art, PUSCH-256QAM is an existing information element, and the terminal may report through the existing information element PUSCH-256QAM that the terminal supports UL 256QAM, that is, the terminal may inform the network device by reporting the PUSCH-256QAM information element that the terminal supports the 256QAM index table; in a case that the network device receives the PUSCH-256QAM information element, the network device can determine whether the terminal supports the 256QAM index table. For another example, the terminal may further report in advance an ul-64QAM-MCS-TableAlt information element, and this information element may indicate whether the terminal supports the low spectral efficiency 64QAM index table, alternatively, the terminal may further report in advance the PUSCH-256QAM to indicate that the terminal supports UL 256QAM.

In one optional embodiment, the PUSCH-256QAM information element may be carried by the capability information, where the capability information may indicate that the terminal supports an UL 256QAM modulation mode, i.e., the 256QAM index table, and supports MCS indices 0-15 or 0-27 or 20-27 in the 256QAM index table. The present disclosure does not impose any limitation on the specific value of the MCS index supported by the terminal and indicated by the capability information, the terminal may make configuration depending on the actual situation.

In one embodiment, the MCS index value indicated by the capability information may include the index value in the 256QAM index table. As an example, in a case that the MCS index value indicated by the capability information includes the index value in the 256QAM index table, i.e., in a case that the terminal supports the index value in the 256QAM index table on respective frequency bands, if the terminal reports in advance that the terminal supports this 256QAM index table, the network device can determine that the terminal can support these index values. If the terminal does not report that the terminal supports the 256QAM index table, or the terminal reports that the terminal does not support the 256QAM index table, the network device may discard or ignore these MCS index values. In another embodiment, if the terminal further supports a 64QAM modulation mode or a low spectral efficiency 64QAM modulation mode, i.e., the terminal supports the 64QAM index table or the low spectral efficiency 64QAM index table, the MCS index value reported by the terminal may further include some or all MCS index values in the 64QAM index table or the low spectral efficiency 64QAM index table.

In one example, the capability information includes one or more capability information elements, each capability information element corresponds to one first MCS index table, and each capability information element includes the MCS index value supported by the terminal in a corresponding first MCS index table.

As an example, the capability information element may be an information element newly defined as compared to that defined in the related art. In specific, the capability information may include a plurality of capability information elements, one capability information element may correspond to one modulation mode, i.e., one MCS index table, for example, there may be one capability information element corresponding to the 256QAM index table, and another capability information element corresponding to the 64QAM index table.

In one embodiment, the first MCS index table is the MCS index table supported by the terminal.

In other words, the terminal supports the MCS index table corresponding to each capability information element reported by the terminal.

As an example, if the terminal supports the 256QAM index table and the 64QAM index table, in a case that the capability information includes a capability information element corresponding to 64QAM, the capability information element may indicate the index value in the 64QAM index table supported by the terminal; in a case that the capability information includes a capability information element corresponding to 256QAM, the capability information element may indicate the index value in the 256QAM index table supported by the terminal.

In one embodiment, the MCS index value indicated by the capability information element may include all index values in the index table corresponding to the capability information element, or may be some index values. As an example, in a case that the terminal supports all index values in the 256QAM index table, the terminal may transmit the capability information element corresponding to the 256QAM index table, and the index value indicated by the capability information element may include all index values in the 256QAM index table. Alternatively, in a case that the terminal supports some index values in the 256QAM index table, the terminal may transmit the capability information element corresponding to 256QAM, and the index value indicated by the capability information element may include some index values supported by the terminal in the 256QAM index table.

In another embodiment, the first index table may further be an MCS index table that is not supported by the terminal. As an example, in a case that the capability information includes a capability information element corresponding to the MCS index table that is not supported by the terminal, the network device may, after receiving the capability information element, further discard or ignore this capability information element. For example, in a case that the network device determines according to the information preciously reported by the terminal device that the terminal does not support the 256QAM index table, the network device, even if receives the capability information element corresponding to 256QAM, may discard or ignore the capability information element.

In one example, in a case that the capability information does not include a capability information element corresponding to a second MCS index table, the capability information indicates all MCS index values supported by the terminal in the second MCS index table; and the second index table is the MCS index table supported by the terminal.

As an example, in a case that the terminal supports all index values in the 256QAM index table, the terminal may not transmit the capability information element corresponding to the 256QAM index table. For example, in a case that a certain terminal does not have a capability of transmitting the capability information element corresponding to the 256QAM index table or is not configured with a relevant capability, if the terminal determines that the terminal supports the 256QAM modulation mode or supports all index values in the 256QAM index table, but the terminal cannot transmit the capability information including the capability information element, the network device based on this capability information still can determine that the terminal supports the 256QAM modulation mode, so that the terminal may be configured with the index value in the 256QAM index table.

Optionally, in a case that the terminal supports all index values corresponding to a certain index table, the terminal may transmit the capability information element corresponding to this index table, or the terminal may not transmit the capability information element corresponding to this index table, which may be set by those skilled in the art according to actual requirement, alternatively, the terminal may make a determination according to its own capability, which is not limited here in the present disclosure.

In one example, the capability information element may be defined as below:

[[

| | |
|---|---|
| MinMaxMCS-Config-UL-256QAM-r18 ::= | SEQUENCE { |
| MinMCS-PUSCH-r18 | INTEGER (0..27), |
| MaxMCS-PUSCH-r18 | INTEGER (0..31) |

]].

In one embodiment, the capability information element may be named as MinMaxMCS-Config-UL-256QAM-r18, where a SEQUENCE parameter corresponding to the information element may indicate a frequency band corresponding to the capability information element, a parameter corresponding to MinMCS-PUSCH-r18 is a minimum index value, a parameter corresponding to MaxMCS-PUSCH-r18 is a maximum index value, the minimum index value may be any integer ranging from 0 to 27, the maximum index value may be any integer ranging from 0 to 31. For example, the network device may determine, after receiving the capability information element and based on the maximum index value and the minimum index value, the index value supported by the terminal in the 256QAM index table.

In specific, the capability information element may only correspond to the 256QAM index table. In one implementation, if the terminal supports the 256QAM modulation mode, the 64QAM modulation mode, and the low spectral efficiency 64QAM modulation mode, it may be taken as a default that the terminal supports all index values in the 64QAM index table, and all index values in the low spectral 64QAM index table, and by reporting the capability information element, specific index values supported by the terminal in the 256QAM index table are indicated, or by not reporting the capability information element, all index values supported by the terminal in the 256QAM index table are indicated.

In this example, when the terminal supports an UL 256QAM modulation, at the same time of reporting this PUSCH-256QAM, by transmitting the capability information element, the MCS index value supported by the terminal in the 256QAM index table is further indicated.

In another example, the capability information element is defined as below:

[[

| | |
|---|---|
| MinMaxMCS-Config-r18 ::= | SEQUENCE { |
| MCS-Table-r18 | ENUMERATED {qam64, qam256, |

qam64LowSE},

| | |
|---|---|
| MinMCS-PUSCH-r18 | INTEGER (0..27), |
| MaxMCS-PUSCH-r18 | INTEGER (0..31) |

]].

In some embodiments, the capability information element may be named as MinMaxMCS-Config-r18. In specific, a SEQUENCE parameter corresponding to the information element may indicate a frequency band corresponding to the capability information element, a parameter corresponding to MCS-Table-r18 may indicate an index table corresponding to the capability information element, this signaling is an enumeration signaling, which can only report one modulation mode at a time, for example, when MCS-Table-r18=qam64, it represents that the capability information element corresponds to 64QAM; when MCS-Table-r18=qam256, it represents that the capability information element corresponds to 256QAM; and when MCS-Table-r18=qam64LowSE, it represents that the capability information element corresponds to low spectral efficiency 64QAM. In addition, the parameter corresponding to MinMCS-PUSCH-r18 is a minimum index value; the parameter corresponding to MaxMCS-PUSCH-r18 is a maximum index value; the minimum index value ranges from 0 to 27; and the maximum index value ranges from 0 to 31. For example, the network device may determine, after receiving the capability information element and based on the maximum index value and the minimum index value, the index value supported by the terminal in the 256QAM index table.

In some optional embodiments, since the terminal is more likely to fail to achieve the expected gain in signal modulation for a high MCS index, the capability information may specifically indicate the high MCS index supported by the terminal. In specific, the high MCS index may refer to an MCS index with an index value higher than a preset threshold. As an example, in a case that the preset threshold is 20, if the terminal supports the 256QAM modulation mode, it may be taken as a default that the terminal can support MCS index values 0-19 in the 256QAM index table, and the capability information only needs to indicate specific index values the terminal supports out of the MCS index values 20-27 in the 256QAM index table. Further, in one possible implementation, the minimum index value in the capability information element may be defaulted as 0, and the maximum index value may range from the preset threshold to 31 or from the preset threshold to 27.

In addition, the terminal for the same frequency band may indicate, by transmitting multiple times the capability information, where the index tables corresponding to the capability information elements included in the capability information transmitted each time may be different, index values supported by the terminal in multiple index tables. The network device may determine the receipt of the capability information corresponding to all index tables supported by the terminal on respective frequency bands, before configure the MCS configuration information. As an example, if the terminal supports 64QAM, 256QAM and low spectral efficiency 64QAM, in a case that multiple capability information transmitted from the terminal on the same frequency band all do not include the capability information element corresponding to 64QAM, it represents that the terminal supports all index values corresponding to the 64QAM index table; in a case that multiple capability information transmitted from the terminal all do not include the capability information element corresponding to low spectral efficiency 64QAM, it may represent that the terminal supports all index values corresponding to the low spectral efficiency 64QAM index table.

In one example, the terminal supports a frequency range 2, i.e., FR2 (Frequency range 2).

For example, the terminal may be an FR2 terminal, and the FR2 terminal may be any terminal that supports a millimeter-wave frequency band between 24.25 GHz and 71 GHz. Referring to the related art, in the FR2, when the terminal supports UL 256QAM, it is found through link simulation that for the high MCS index, 256QAM cannot achieve the expected gain compared to UL 64QAM. In this way, the terminal can effectively ensure, by transmitting the capability information that indicates the MCS index supported by the terminal, that the FR2 terminal 256QAM can achieve the expected gain.

In one example, the terminal may further perform, after performing the step S201, the following step: receiving, by the terminal, MCS configuration information transmitted from the network device, the MCS configuration information is used to configure the MCS index value supported by the terminal on one or more frequency bands.

With respect to detailed description for this step, reference may be made to the detailed description corresponding to the step S302 as shown in FIG. 3, which is not repeated here.

In an embodiment of the present disclosure, the terminal can, by transmitting the capability information that indicates the MCS index value supported by the terminal, where the MCS index value indicated by the capability information may only include the index value supported by the terminal, report the terminal's capability more accurately, avoiding the terminal from being unable to achieve the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

FIG. 3 is a flow chart illustrating a capability reporting method according to an illustrative embodiment, the method is applied to a terminal, as shown in FIG. 3, and the method includes S301 and S302.

At S301, the terminal transmits capability information of the terminal to a network device, where the capability information indicates a modulation and coding scheme (MCS) index value supported by the terminal on one or more frequency bands, and the MCS index value includes some or all MCS index values in one or more MCS index tables.

With respect to detailed contents for the step S301, reference may be made to the detailed description corresponding to the step S201 as shown in FIG. 2, which is not repeated here.

At S302, the terminal receives MCS configuration information transmitted from the network device, where the MCS configuration information is used to configure the MCS index value supported by the terminal on the one or more frequency bands.

In specific, the information used to configure the MCS index value supported by the terminal on the one or more frequency bands may be the MCS configuration information described above, or may be MCS index indication information, or may also be DCI, which is not limited in the present disclosure.

As an example, the terminal may perform, after receiving the MCS configuration information, signal modulation and transmission on respective frequency bands according to the MCS index value indicated by the MCS configuration information, so that the MCS index value configured according to the MCS configuration information is the MCS index value supported by the terminal.

In one embodiment, the MCS configuration information specifically may indicate a modulation mode for signal selection by the terminal, and specifically may indicate the MCS index table and the MCS index value used by the terminal.

As an example, the MCS configuration information may be carried by a DCI and/or RRC signaling.

For example, the MCS index table may be specifically indicated by physical downlink shared channel (PDSCH)-Config in the RRC signaling and an MCS-Table parameter in semi-persistent scheduling (SPS)-Config, so that the terminal performs modulation based on the MCS index table indicated by the MCS configuration information.

For another example, the MCS index value used by the terminal may be dynamically configured via DCI, for example, in a case that the network device determines a change in a wireless link quality with the terminal, the MCS configuration information may be reconfigured based on the capability information of the terminal and transmitted to the terminal via DCI, so that the terminal can perform signal modulation on respective frequency bands based on the MCS index value dynamically indicated via DCI.

Optionally, the MCS index value configured according to the MCS configuration information may be determined according to the MCS index value supported by the terminal and indicated by the capability information, so that the MCS index value corresponding to the MCS configuration information is within an MCS index value range reported by the terminal, for example, the capability information indicates MCS index values 0-15 supported by the terminal in the 256QAM index table, and the MCS configuration information may indicate the terminal to use the MCS index values 0-15, or 0-10, or 10-15 in the 256QAM index table for signal modulation.

In other possible implementations, the MCS configuration information specifically may be configured by a core network device and transmitted to a base station, and then further transmitted by the base station to the terminal.

In an embodiment of the present disclosure, the terminal can, by transmitting the capability information that indicates the MCS index value supported by the terminal and receiving the MCS configuration information configured by the network device according to the capability information, report the terminal's capability more accurately, so that the network device can perform MCS configuration based on the terminal's capability, thus avoiding the terminal from being unable to obtain the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

FIG. 4 is a flow chart illustrating a capability reporting method according to an illustrative embodiment, the method is applied to a terminal, as shown in FIG. 4, and the method includes S401 and S402.

At S401, the terminal transmits an MCS index table supported by the terminal to a network device.

In one example, the terminal specifically may further transmit the MCS index table supported by the terminal on one or more frequency bands.

As an example, a specific MCS index table the terminal supports may be reported to the network device by transmission through other signaling or information elements, such as through UCI. In this way, in a case that the terminal determines that the terminal supports a certain MCS index table, the terminal may transmit in advance, prior to transmitting the capability information, information that indicates the MCS index table supported by the terminal, so that the network device configures the modulation mode of the terminal based on the index table supported by the terminal.

At S402, the terminal transmits the capability information of the terminal to the network device, where the capability information indicates an MCS index value supported by the terminal on one or more frequency bands, and the MCS index value includes some or all MCS index values in one or more MCS index tables.

With respect to detailed contents for the step S402, reference may be made to the detailed description corresponding to the step S201 as shown in FIG. 2, which is not repeated here.

In an embodiment of the present disclosure, the terminal can, by transmitting the MCS index table supported by the terminal and transmitting the capability information that indicates the MCS index value supported by the terminal, enable the network device to more accurately know the MCS index table supported by the terminal, and at the same time, know the MCS index value supported by the terminal, so that the network device can perform more reliable MCS configuration based on the terminal's capability, thus avoiding the terminal from being unable to obtain the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

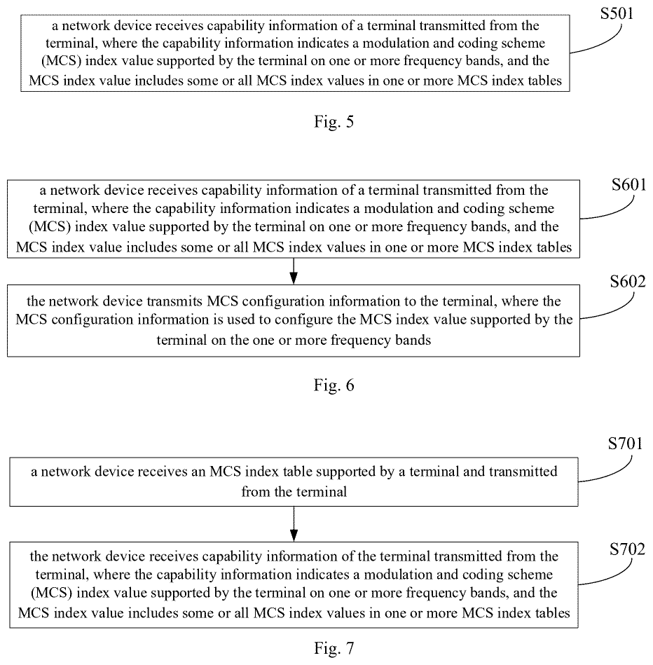

FIG. 5 is a flow chart illustrating a capability reporting method according to an illustrative embodiment, the method is applied to a network device, as shown in FIG. 5, and the method includes S501.

At S501, the network device receives capability information of a terminal transmitted from the terminal, where the capability information indicates a modulation and coding scheme (MCS) index value supported by the terminal on one or more frequency bands, and the MCS index value includes some or all MCS index values in one or more MCS index tables.

In specific, the capability information may be carried by a physical uplink shared channel (PUSCH) or may be carried by other uplink signals. In some possible implementations, the capability information may further include other information indicating other capabilities of the terminal, for example, may include a current load of the terminal, a processing capability of its own, and the MCS index table supported by the terminal, etc., which is not specifically limited by the present disclosure. In addition, the capability information indicating the MCS index value supported by the terminal on one or more frequency bands may be the above-described capability information, or may also be any other information, such as uplink control information (UCI) or the like, which is not limited by the present disclosure.

It should be noted that the MCS index value supported by the terminal may refer to the MCS index value that allows the terminal to achieve the expected gain, or refer to the MCS index value that allows the gain to meet a preset condition. As an example, some MCS index values that are not included in the capability information may be the MCS index values that are not supported by the terminal.

In addition, the MCS index value may also be described as an MCS index or an MCS value, while the MCS index table may also be described as an MCS table or an MCS sheet, etc., which are not limited in the present disclosure.

In one embodiment, the MCS index table supported by the terminal may specifically refer to the MCS index table supported by the terminal on one or more frequency bands corresponding to the capability information. Optionally, if the terminal supports a certain MCS index table, it indicates that the terminal supports a modulation mode corresponding to this index table, and vice versa.

In one example, the MCS index value indicated by the capability information includes some or all MCS index values in the MCS index table supported by the terminal.

As an example, after determining that the terminal supports a certain MCS index table on a certain frequency band, the terminal may determine, according to its own capability, a wireless link quality or the like, an index value with a good gain in the MCS index table supported by the terminal, and indicates through the capability information these index values to the network device.

As another example, in a case that the capability information includes an MCS index value corresponding to an MCS index table that is not supported by the terminal, after receiving the capability information, the network device may further discard or ignore these index values in the capability information. For example, in a case that the network device determines according to the information previously reported by the terminal device that the terminal does not support the 256QAM index table, even if the network device receives an index value corresponding to 256QAM, the network device may discard or ignore these index value.

In one embodiment, the MCS index value supported by the terminal may be an MCS index value supported by the terminal on each frequency band, or may be an MCS index value supported by the terminal on a certain frequency band. In one embodiment, by transmitting the capability information multiple times, the terminal may also indicate the MCS index value supported by the terminal on each frequency band. In some embodiments, the MCS index value may be represented as IMcs, the index value may range from 0 to 31, in one same index table, the higher the index value is, the more valid bits can be transmitted in one symbol, i.e., the higher the signal quality is, where 29 to 31 may be reservation indices. In some embodiments, specific index values the terminal supports may be determined according to the terminal's capability, the network device's capability, and/or the wireless link's quality. For example, if the terminal does not support an MCS index 26 in the 256QAM index table, the MCS index value indicated by the capability information may not include the MCS index 26.

In one example, the MCS index table supported by the terminal includes one or more of a 256QAM index table, a 64QAM index table, and a low spectral efficiency 64QAM index table.

In some embodiments, specific index tables the terminal supports may be determined according to the terminal's capability, the network device's capability, and/or the wireless link's quality. Further, in addition to the index tables described above, the MCS index table supported by the terminal may include a 2048QAM index table in a case that other index tables are further defined or the terminal and the network device are further improved with the technology development, e.g., the terminal and the network device can support a 2048QAM modulation mode, accordingly, the MCS index value indicated by the capability information may further include an index value in the 2048QAM index table.

In one example, the capability information further indicates the MCS index table supported by the terminal.

Alternatively, in another example, prior to receiving the capability information of the terminal transmitted from the terminal, the method further includes:

receiving the MCS index table supported by the terminal and transmitted from the terminal.

With respect to detailed contents for the step of receiving the MCS index table supported by the terminal and transmitted from the terminal, detailed description corresponding to the step S701 as shown in FIG. 7 may be referred to, which will not be repeated here.

As an example, a specific MCS index table the terminal supports may be reported to the network device by transmission through other signaling or information elements, or may be reported to the network device through the capability information. In other words, in a case that the terminal determines that the terminal supports a certain MCS index table, the terminal may transmit in advance, prior to transmitting the capability information, the information that indicates the MCS index table supported by the terminal; alternatively, the terminal may further transmit the information that indicates the MCS index table supported by the terminal and that is carried by the capability information.

For example, the capability information specifically may further indicate the MCS index table supported by the terminal and the MCS index value corresponding to the MCS index table supported by the terminal. In specific, the information element that indicates the MCS index table supported by the terminal may be different from the information element that indicates the MCS index value supported by the terminal.

As an example, in the related art, PUSCH-256QAM is an existing information element, and the terminal may report through the existing information element PUSCH-256QAM that the terminal supports UL 256QAM, that is, the terminal may inform the network device by reporting the PUSCH-256QAM information element that the terminal supports the 256QAM index table; in a case that the network device receives the PUSCH-256QAM information element, the network device can determine whether the terminal supports the 256QAM index table. For another example, the terminal may further report in advance an ul-64QAM-MCS-TableAlt information element, and this information element may indicate whether the terminal supports the low spectral efficiency 64QAM index table, alternatively, the terminal may further report in advance the PUSCH-256QAM to indicate that the terminal supports UL 256QAM.

In one optional embodiment, the PUSCH-256QAM information element may be carried by the capability information, where the capability information may indicate that the terminal supports an UL 256QAM modulation mode, i.e., the 256QAM index table, and supports MCS indices 0-15 or 0-27 or 20-27 in the 256QAM index table. The present disclosure does not impose any limitation on the specific value of the MCS index supported by the terminal and indicated by the capability information, the terminal may make configuration depending on the actual situation.

In one embodiment, the MCS index value indicated by the capability information may include the index value in the 256QAM index table. As an example, in a case that the MCS index value indicated by the capability information includes the index value in the 256QAM index table, i.e., in a case that the terminal supports the index value in the 256QAM index table on respective frequency bands, if the terminal reports in advance that the terminal supports this 256QAM index table, the network device can determine that the terminal can support these index values. If the terminal does not report that the terminal supports the 256QAM index table, or the terminal reports that the terminal does not support the 256QAM index table, the network device may discard or ignore these MCS index values. In another embodiment, if the terminal further supports a 64QAM modulation mode or a low spectral efficiency 64QAM modulation mode, i.e., the terminal supports the 64QAM index table or the low spectral efficiency 64QAM index table, the MCS index value reported by the terminal may further include some or all MCS index values in the 64QAM index table or the low spectral efficiency 64QAM index table.

In one example, the capability information includes one or more capability information elements, each capability information element corresponds to one first MCS index table, and each capability information element includes the MCS index value supported by the terminal in a corresponding first MCS index table.

As an example, the capability information element may be an information element newly defined as compared to that defined in the related art. In specific, the capability information may include a plurality of capability information elements, one capability information element may correspond to one modulation mode, i.e., one MCS index table, for example, there may be one capability information element corresponding to the 256QAM index table, and another capability information element corresponding to the 64QAM index table.

In one embodiment, the first MCS index table is the MCS index table supported by the terminal.

In other words, the terminal supports the MCS index table corresponding to each capability information element reported by the terminal.

As an example, if the terminal supports the 256QAM index table and the 64QAM index table, in a case that the capability information includes a capability information element corresponding to 64QAM, the capability information element may indicate the index value in the 64QAM index table supported by the terminal; in a case that the capability information includes a capability information element corresponding to 256QAM, the capability information element may indicate the index value in the 256QAM index table supported by the terminal.

In one embodiment, the MCS index value indicated by the capability information element may include all index values in the index table corresponding to the capability information element, or may be some index values. As an example, in a case that the terminal supports all index values in the 256QAM index table, the terminal may transmit the capability information element corresponding to the 256QAM index table, and the index value indicated by the capability information element may include all index values in the 256QAM index table. Alternatively, in a case that the terminal supports some index values in the 256QAM index table, the terminal may transmit the capability information element corresponding to 256QAM, and the index value indicated by the capability information element may include some index values supported by the terminal in the 256QAM index table.

In another embodiment, the first index table may further be an MCS index table that is not supported by the terminal. As an example, in a case that the capability information includes a capability information element corresponding to the MCS index table that is not supported by the terminal, the network device may, after receiving the capability information element, further discard or ignore this capability information element. For example, in a case that the network device determines according to the information preciously reported by the terminal device that the terminal does not support the 256QAM index table, the network device, even if receives the capability information element corresponding to 256QAM, may discard or ignore the capability information element.

In one example, in a case that the capability information does not include a capability information element corresponding to a second MCS index table, the capability information indicates all MCS index values supported by the terminal in the second MCS index table; and the second index table is the MCS index table supported by the terminal.

As an example, in a case that the terminal supports all index values in the 256QAM index table, the terminal may not transmit the capability information element corresponding to the 256QAM index table. For example, in a case that a certain terminal does not have a capability of transmitting the capability information element corresponding to the 256QAM index table or is not configured with a relevant capability, if the terminal determines that the terminal supports the 256QAM modulation mode or supports all index values in the 256QAM index table, the terminal may transmit capability information not including the capability information element, so that network device still can configure the terminal with the index value in the 256QAM index table.

Optionally, in a case that the terminal supports all index values corresponding to a certain index table, the terminal may transmit the capability information element corresponding to this index table, or the terminal may not transmit the capability information element corresponding to this index table, which may be set by those skilled in the art according to actual requirement, alternatively, the terminal may make a determination according to its own capability, which is not limited here in the present disclosure.

In one example, the capability information element may be defined as below:

[[

| | |
|---|---|
| MinMaxMCS-Config-UL-256QAM-r18 ::= | SEQUENCE { |
| MinMCS-PUSCH-r18 | INTEGER (0..27), |
| MaxMCS-PUSCH-r18 | INTEGER (0..31) |

]].

In one embodiment, the capability information element may be named as MinMaxMCS-Config-UL-256QAM-r18, where a SEQUENCE parameter corresponding to the information element may indicate a frequency band corresponding to the capability information element, a parameter corresponding to MinMCS-PUSCH-r18 is a minimum index value, a parameter corresponding to MaxMCS-PUSCH-r18 is a maximum index value, the minimum index value may be any integer ranging from 0 to 27, the maximum index value may be any integer ranging from 0 to 31. For example, the network device may determine, after receiving the capability information element and based on the maximum index value and the minimum index value, the index value supported by the terminal in the 256QAM index table.

In specific, the capability information element may only correspond to the 256QAM index table. In one implementation, if the terminal supports the 256QAM modulation mode, the 64QAM modulation mode, and the low spectral efficiency 64QAM modulation mode, it may be taken as a default that the terminal supports all index values in the 64QAM index table, and all index values in the low spectral 64QAM index table, and by reporting the capability information element, specific index values supported by the terminal in the 256QAM index table are indicated, or by not reporting the capability information element, all index values supported by the terminal in the 256QAM index table are indicated.

In this example, when the terminal supports an UL 256QAM modulation, at the same time of reporting this PUSCH-256QAM, by transmitting the capability information element, the MCS index value supported by the terminal in the 256QAM index table is further indicated.

In another example, the capability information element is defined as below:

[[

| | |
|---|---|
| MinMaxMCS-Config-r18 ::= | SEQUENCE { |
| MCS-Table-r18 | ENUMERATED {qam64, qam256, |

qam64LowSE},

| | |
|---|---|
| MinMCS-PUSCH-r18 | INTEGER (0..27), |
| MaxMCS-PUSCH-r18 | INTEGER (0..31) |

]].

In some embodiments, the capability information element may be named as MinMaxMCS-Config-r18. In specific, a SEQUENCE parameter corresponding to the information element may indicate a frequency band corresponding to the capability information element, a parameter corresponding to MCS-Table-r18 may indicate an index table corresponding to the capability information element, this signaling is an enumeration signaling, which can only report one modulation mode at a time, for example, when MCS-Table-r18=qam64, it represents that the capability information element corresponds to 64QAM; when MCS-Table-r18=qam256, it represents that the capability information element corresponds to 256QAM; and when MCS-Table-r18=qam64LowSE, it represents that the capability information element corresponds to low spectral efficiency 64QAM. In addition, the parameter corresponding to MinMCS-PUSCH-r18 is a minimum index value; the parameter corresponding to MaxMCS-PUSCH-r18 is a maximum index value; the minimum index value ranges from 0 to 27; and the maximum index value ranges from 0 to 31. For example, the network device may determine, after receiving the capability information element and based on the maximum index value and the minimum index value, the index value supported by the terminal in the 256QAM index table.

In some optional embodiments, since the terminal is more likely to fail to achieve the expected gain in signal modulation for a high MCS index, the capability information may specifically indicate the high MCS index supported by the terminal. In specific, the high MCS index may refer to an MCS index with an index value higher than a preset threshold. As an example, in a case that the preset threshold is 20, if the terminal supports the 256QAM modulation mode, it may be taken as a default that the terminal can support MCS index values 0-19 in the 256QAM index table, and the capability information only needs to indicate specific index values the terminal supports out of the MCS index values 20-27 in the 256QAM index table. Further, in one possible implementation, the minimum index value in the capability information element may be defaulted as 0, and the maximum index value may range from the preset threshold to 31 or from the preset threshold to 27.

In addition, the terminal for the same frequency band may indicate, by transmitting multiple times the capability information, where the index tables corresponding to the capability information elements included in the capability information transmitted each time may be different, index values supported by the terminal in multiple index tables. The network device may determine the receipt of the capability information corresponding to all index tables supported by the terminal on respective frequency bands, before configure the MCS configuration information.

Further, if the terminal supports 64QAM, 256QAM and low spectral efficiency 64QAM, in a case that multiple capability information transmitted from the terminal on the same frequency band all do not include the capability information element corresponding to 64QAM, it represents that the terminal supports all index values corresponding to the 64QAM index table; in a case that multiple capability information transmitted from the terminal all do not include the capability information element corresponding to low spectral efficiency 64QAM, it may represent that the terminal supports all index values corresponding to the low spectral efficiency 64QAM index table.

In one example, the terminal supports a frequency range 2, i.e., FR2.

For example, the terminal may be an FR2 terminal, and the FR2 terminal may be any terminal that supports a millimeter-wave frequency band between 24.25 GHz and 71 GHz. Referring to the related art, in the FR2, when the terminal supports UL 256QAM, it is found through link simulation that for the high MCS index, 256QAM cannot achieve the expected gain compared to UL 64QAM. In this way, the terminal can effectively ensure, by transmitting the capability information that indicates the MCS index supported by the terminal, that the FR2 terminal 256QAM can achieve the expected gain.

In one example, the base station may further perform, after performing the step S501, the following step: transmitting MCS configuration information to a terminal, where the MCS configuration information is used to configure the MCS index value supported by the terminal on one or more frequency bands.

With respect to detailed description for this step, reference may be made to the detailed description corresponding to the step S602 as shown in FIG. 6, which is not repeated here.

In an embodiment of the present disclosure, the network device can, by receiving the capability information that indicates the MCS index value supported by the terminal, where the MCS index value indicated by the capability information may only include the index value supported by the terminal, know the terminal's capability more accurately for configuration of the terminal, thus avoiding the terminal from being unable to achieve the expected gain for some index values corresponding to the modulation mode supported by the terminal, thereby ensuring transmission reliability.

FIG. 6 is a flow chart illustrating a capability reporting method according to an illustrative embodiment, the method is applied to a network device, as shown in FIG. 6, and the method includes S601 and S602.

At S601, the network device receives capability information of a terminal transmitted from the terminal, where the capability information indicates a modulation and coding scheme (MCS) index value supported by the terminal on one or more frequency bands, and the MCS index value includes some or all MCS index values in one or more MCS index tables.

With respect to detailed contents for the step S601, reference may be made to the detailed description corresponding to the step S501 as shown in FIG. 5, which is not repeated here.

At S602, the network device transmits MCS configuration information to the terminal, where the MCS configuration information is used to configure the MCS index value supported by the terminal on the one or more frequency bands.

In specific, the information used to configure the MCS index value supported by the terminal on the one or more frequency bands may be the MCS configuration information described above, or may be MCS index indication information, or may also be DCI, which is not limited in the present disclosure.

As an example, the terminal may perform, after receiving the MCS configuration information, signal modulation and transmission on respective frequency bands according to the MCS index value indicated by the MCS configuration information, so that the MCS index value configured according to the MCS configuration information is the MCS index value supported by the terminal.

In one example, the network device may determine the MCS configuration information according to the MCS index value indicated by the capability information, so that the MCS index value corresponding to the MCS configuration information is within an MCS index value range reported by the terminal, for example, the capability information indicates MCS index values 0-15 supported by the terminal in the 256QAM index table, and the MCS configuration information may indicate the terminal to use the MCS index values 0-15, or 0-10, or 10-15 in the 256QAM index table for signal modulation.

In one embodiment, the MCS configuration information specifically may indicate a modulation mode for signal selection by the terminal, and specifically may indicate the MCS index table and the MCS index value.

As an example, the MCS configuration information may be carried by a DCI and/or RRC signaling.

For example, the MCS index table may be specifically indicated by physical downlink shared channel (PDSCH)-Config in the RRC signaling and an MCS-Table parameter in semi-persistent scheduling (SPS)-Config, so that the terminal performs modulation based on the MCS index table indicated by the MCS configuration information.

For another example, the MCS index value used by the terminal may be dynamically configured via DCI, for example, in a case that the network device determines a change in a wireless link quality with the terminal, the MCS configuration information may be reconfigured based on the capability information of the terminal and transmitted to the terminal via DCI, so that the terminal can perform signal modulation on respective frequency bands based on the MCS index value dynamically indicated via DCI.

Optionally, the MCS index value configured according to the MCS configuration information may be determined according to the MCS index value supported by the terminal and indicated by the capability information, so that the MCS index value corresponding to the MCS configuration information is within an MCS index value range reported by the terminal, for example, the capability information indicates MCS index values 0-15 supported by the terminal in the 256QAM index table, and the MCS configuration information may indicate the terminal to use the MCS index values 0-15, or 0-10, or 10-15 in the 256QAM index table for signal modulation.

In other possible implementations, the MCS configuration information specifically may be configured by a core network device and transmitted to a base station, and then further transmitted by the base station to the terminal.

In an embodiment of the present disclosure, the terminal can, by transmitting the capability information that indicates the MCS index value supported by the terminal and receiving the MCS configuration information configured by the network device according to the capability information, report the terminal's capability more accurately, so that the network device can perform MCS configuration based on the terminal's capability, thus avoiding the terminal from being unable to obtain the expected gain for some index values corresponding to the modulation mode supported by the terminal, thereby ensuring transmission reliability.

In an embodiment of the present disclosure, the network device can, by receiving the capability information that indicates the MCS index value supported by the terminal and configuring the MCS configuration information according to the capability information, know the terminal′ capability more accurately, so that the MCS configuration can be performed based on the terminal′ capability, thus avoiding the terminal from being unable to obtain the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

FIG. 7 is a flow chart illustrating a capability reporting method according to an illustrative embodiment, the method is applied to a network device, as shown in FIG. 7, and the method includes S701 and S702.

At S701, the network device receives an MCS index table supported by a terminal and transmitted from the terminal.

In one embodiment, the terminal specifically may further transmit the MCS index table supported by the terminal on one or more frequency bands.

As an example, a specific MCS index table the terminal supports may be reported to the network device by transmission through other signaling or information elements, such as via UCI. In this way, in a case that the terminal determines that the terminal supports a certain MCS index table, the terminal may transmit in advance, prior to transmitting the capability information, information that indicates the MCS index table supported by the terminal, so that the network device configures the modulation mode of the terminal based on the index table supported by the terminal.

At S702, the network device receives capability information of the terminal transmitted from the terminal, where the capability information indicates a modulation and coding scheme (MCS) index value supported by the terminal on one or more frequency bands, and the MCS index value includes some or all MCS index values in one or more MCS index tables.

With respect to detailed contents for the step S702, reference may be made to the detailed description corresponding to the step S501 as shown in FIG. 5, which is not repeated here.

In an embodiment of the present disclosure, the network device can, by receiving in advance the index table information transmitted from the terminal to know the MCS index table supported by the terminal and further receiving the capability information, determine more reliably the MCS index value supported by the terminal on the one or more frequency bands, so that the network device can know the terminal's capability more accurately and so that the network device can perform MCS configuration based on the terminal's capability, thus avoiding the terminal from being unable to obtain the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

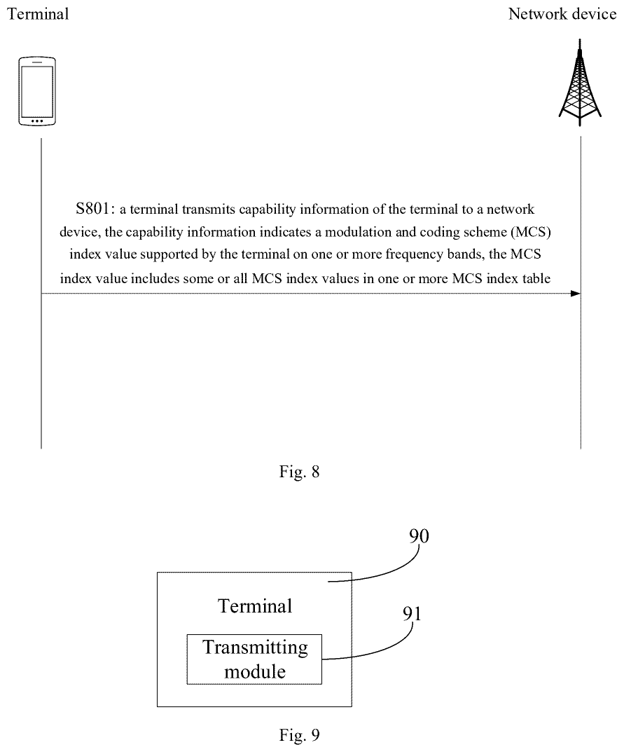

FIG. 8 is an interaction diagram illustrating a capability reporting method according to an illustrative embodiment, as shown in FIG. 8, the method includes S801.

At S801, a terminal transmits capability information of the terminal to a network device, where the capability information indicates a modulation and coding scheme (MCS) index value supported by the terminal on one or more frequency bands, and the MCS index value includes some or all MCS index values in one or more MCS index table.

Prior to the step S801, the method may further include a step: transmitting, by the terminal, an MCS index table supported by the terminal to the network device.

Besides, after the step S801, the method may further include a step: transmitting, by the network device, MCS configuration information to the terminal, where the MCS configuration information is used to configure the MCS index value supported by the terminal on the one or more frequency bands.

Further, the terminal can, after receiving the MCS configuration information, perform configuration of the MCS index value on the one or more frequency bands according to the MCS configuration information, so that the signal gain on these frequency bands can meet expectation.

Specific details of various steps involved in the above embodiments of the present disclosure have been described in detail in the embodiments involving respective related steps, and will not be elaborated here.

In an embodiment of the present disclosure, the terminal can, by transmitting the capability information that indicates the MCS index value supported by the terminal, where the MCS index value indicated by the capability information may only include the index value supported by the terminal, report the terminal's capability more accurately, avoiding the terminal from being unable to achieve the expected gain for some index values corresponding to the modulation mode supported by the terminal, thereby ensuring transmission reliability.

In the absence of contradiction, embodiments of the present disclosure may be combined with other embodiments or implementations involving the capability reporting method, or mutual combinations of various optional solutions, which is not elaborated here.

FIG. 9 is a block diagram illustrating a terminal according to an illustrative embodiment. As shown in FIG. 9, the terminal 90 includes:

a transmitting module 91, configured to transmit capability information of the terminal to a network device, where the capability information indicates a modulation and coding scheme (MCS) index value supported by the terminal on one or more frequency bands, and the MCS index value includes some or all MCS index values in one or more MCS index tables.

Optionally, the terminal 90 includes:

a receiving module, configured to receive MCS configuration information transmitted from the network device, where the MCS configuration information is used to configure the MCS index value supported by the terminal on the one or more frequency bands.

Optionally, the MCS index value includes some or all MCS index values in an MCS index table supported by the terminal.

Optionally, the capability information includes one or more capability information elements, each capability information element corresponds to one first MCS index table, and each capability information element includes the MCS index value supported by the terminal in a corresponding first MCS index table.

Optionally, the first MCS index table is the MCS index table supported by the terminal.

Optionally, in a case that the capability information does not include a capability information element corresponding to a second MCS index table, the capability information indicates all MCS index values supported by the terminal in the second MCS index table; and the second MCS index table is the MCS index table supported by the terminal.

Optionally, the capability information further indicates the MCS index table supported by the terminal.

Optionally, the terminal 90 further includes:
a first transmitting module, configured to transmit the MCS index table supported by the terminal to the network device.

Optionally, the MCS index table supported by the terminal includes one or more of a 256 quadrature amplitude modulation (QAM) index table, a 64QAM index table, and a low spectral efficiency 64QAM index table.

Optionally, the terminal supports a frequency range 2, FR2.

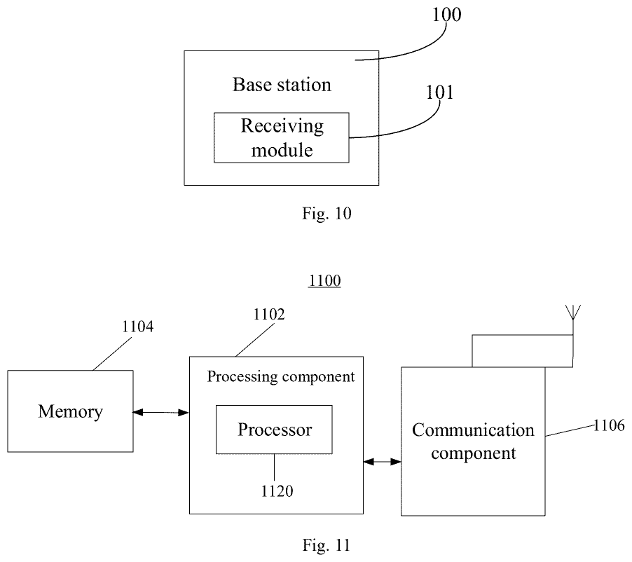

FIG. 10 is a block diagram illustrating a network device according to an illustrative embodiment, as shown in FIG. 10, the network device 100 includes:
a receiving module 101, configured to receive capability information of a terminal transmitted from the terminal, where the capability information indicates a modulation and coding scheme (MCS) index value supported by the terminal on one or more frequency bands, and the MCS index value includes some or all MCS index values in one or more MCS index tables.

Optionally, the network device 100 includes:
a transmitting module, configured to transmit MCS configuration information to the terminal, where the MCS configuration information is used to configure the MCS index value supported by the terminal on the one or more frequency bands.

Optionally, the MCS index value includes some or all MCS index values in an MCS index table supported by the terminal.

Optionally, the capability information includes one or more capability information elements, each capability information element corresponds to one first MCS index table, and each capability information element includes the MCS index value supported by the terminal in a corresponding first MCS index table.

Optionally, the first MCS index table is the MCS index table supported by the terminal.

Optionally, in a case that the capability information does not include a capability information element corresponding to a second MCS index table, the capability information indicates all MCS index values supported by the terminal in the second MCS index table; and the second MCS index table is the MCS index table supported by the terminal.

Optionally, the capability information further indicates the MCS index table supported by the terminal.

Optionally, the network device 100 further includes:
a first receiving module, configured to receive the MCS index table supported by the terminal and transmitted from the terminal.

Optionally, the MCS index table supported by the terminal includes one or more of a 256 quadrature amplitude modulation (QAM) index table, a 64QAM index table, and a low spectral efficiency 64QAM index table.

Optionally, the terminal supports a frequency range 2, FR2.

With respect to the apparatus in the above embodiments, specific ways in which various modules perform operations have been described in detail in the embodiments involving the related method, and will not be elaborated here.

FIG. 11 is a block diagram illustrating a communication apparatus according to an illustrative embodiment. The communication apparatus 1100 may be a terminal device or a network device in the communication system as shown in FIG. 1.

Referring to FIG. 11, the apparatus 1100 may include one or more of the following components: a processing component 1102, a memory 1104, and a communication component 1106.

The processing component 1102 may be used to control overall operations of the apparatus 1100, such as the operations associated with display, telephone calls, data communications, camera operations, and recording operations. The processing component 1102 may include one or more processors 1120 to execute instructions to perform all or part of the steps in the above described capability reporting methods. Moreover, the processing component 1102 may include one or more modules which facilitate the interaction between the processing component 1102 and other components. For instance, the processing component 1102 may include a multimedia module to facilitate the interaction between the multimedia component and the processing component 1102.

The memory 1104 is configured to store various types of data to support the operation of the apparatus 1100. Examples of such data include instructions for any applications or methods operated on the apparatus 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The communication component 1106 is configured to facilitate communication, wired or wirelessly, between the apparatus 1100 and other devices. The apparatus 1100 can access a wireless network based on a communication standard, such as wireless fidelity (Wi-Fi), 2nd-generation (2G), 3rd-generation (3G), 4th-generation (4G), 5th-generation (5G), 6th-generation (6G), narrow band Internet of Things (NB-IoT), enhanced machine-type communication (eMTC), or a combination thereof. In one illustrative embodiment, the communication component 1106 receives a broadcast signal or broadcast associated information from an external broadcast management system via a broadcast channel. In one illustrative embodiment, the communication component 1106 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In illustrative embodiments, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described capability reporting methods.

The apparatus 1100 may be a separate electronic device or a part of a separate electronic device. For example, in one embodiment, the electronic device may be an integrated circuit (IC) or a chip, where the integrated circuit may be one IC or a collection of multiple ICs. The chip may include but is not limited to the following types: a graphics processing unit (GPU), a central processing unit (CPU), a field programmable gate array (FPGA), a digital signal processor (DSP), an application specific integrated circuit (ASIC), a system on chip, a System on Chip (SoC), etc. The integrated circuit or chip described above may be used to execute an executable instruction (or code) to implement the capability reporting method described above. The executable instruction may be stored in the integrated circuit or chip, or obtained from other apparatuses or devices, such as a processor, a memory, and an interface for communication with other apparatuses included in the integrated circuit or chip. The executable instruction may be stored in the processor, and when executed by the processor implements the capability reporting method described above. Alternatively, the integrated circuit or chip may receive the executable instruction through the interface and transmit the executable instruction to the processor for execution, so as to implement the capability reporting method described above.

In an illustrative embodiment, the present disclosure also provides a computer-readable storage medium having stored thereon a computer program instruction that, when executed by a processor, implements a step of the capability reporting method provided in the present disclosure. As an example, the computer-readable storage medium may be a non-temporary computer-readable storage medium including an instruction, such as the memory 1104 including an instruction, the instruction can be executed by the processor 1120 of the apparatus 1100 to complete the capability reporting method described above. For example, the non-temporary computer-readable storage medium may be a read only memory (ROM), a random access memory (RAM), a compact disc read-only memory (CD-ROM), a magnetic tape, a floppy disk, and an optical data storage device.

In another illustrative embodiment, there is also provided a computer program product including a computer program executable by a programmable apparatus, where the computer program has a code portion that, when executed by the programmable apparatus, executes the capability reporting method described above.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as illustrative only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed:

1. A capability reporting method, applied to a terminal, and comprising:
transmitting capability information of the terminal to a network device, wherein the capability information indicates a modulation and coding scheme (MCS) index value supported by the terminal on one or more frequency bands, and the MCS index value comprises some or all MCS index values in one or more MCS index tables.

2. The method according to claim 1, comprising:
receiving MCS configuration information transmitted from the network device, wherein the MCS configuration information is used to configure the MCS index value supported by the terminal on the one or more frequency bands.

3. The method according to claim 1, wherein the MCS index value comprises some or all MCS index values in an MCS index table supported by the terminal.

4. The method according to claim 1, wherein the capability information comprises one or more capability information elements, each capability information element corresponds to one first MCS index table, and each capability information element comprises the MCS index value supported by the terminal in a corresponding first MCS index table.

5. The method according to claim 4, wherein the first MCS index table is the MCS index table supported by the terminal.

6. The method according to claim 1, wherein in a case that the capability information does not comprise a capability information element corresponding to a second MCS index table, the capability information indicates all MCS index values supported by the terminal in the second MCS index table; and the second MCS index table is the MCS index table supported by the terminal.

7. The method according to claim 1, wherein the capability information further indicates the MCS index table supported by the terminal.

8. The method according to claim 1, wherein prior to transmitting the capability information of the terminal to the network device, the method further comprises:
transmitting the MCS index table supported by the terminal to the network device.

9. The method according to claim 3, wherein the MCS index table supported by the terminal comprises one or more of a 256 quadrature amplitude modulation (QAM) index table, a 64QAM index table, and a low spectral efficiency 64QAM index table.

10. The method according to claim 1, wherein the terminal supports a frequency range 2, FR2.

11. A capability reporting method, applied to a network device, and comprising:
receiving capability information of a terminal transmitted from the terminal, wherein the capability information indicates a modulation and coding scheme (MCS) index value supported by the terminal on one or more frequency bands, and the MCS index value comprises some or all MCS index values in one or more MCS index tables.

12. The method according to claim 11, comprising:
transmitting MCS configuration information to the terminal, wherein the MCS configuration information is used to configure the MCS index value supported by the terminal on the one or more frequency bands.

13. (canceled)

14. The method according to claim 11, wherein the capability information comprises one or more capability information elements, each capability information element corresponds to one first MCS index table, and each capability information element comprises the MCS index value supported by the terminal in a corresponding first MCS index table.

15. (canceled)

16. The method according to claim 11, wherein in a case that the capability information does not comprise a capability information element corresponding to a second MCS index table, the capability information indicates all MCS index values supported by the terminal in the second MCS index table; and the second MCS index table is the MCS index table supported by the terminal.

17. The method according to claim 11, wherein the capability information further indicates the MCS index table supported by the terminal.

18. The method according to claim 11, wherein prior to receiving the capability information of the terminal transmitted from the terminal, the method further comprises:
receiving the MCS index table supported by the terminal and transmitted from the terminal.

19. (canceled)

20. (canceled)

21. (canceled)

22. (canceled)

23. (canceled)

24. A communication apparatus, comprising:
a processor; and
a memory configured to store instructions executable by the processor,
wherein the processor is configured to execute the instructions to cause the communication apparatus to perform:
transmitting capability information of the communication apparatus to a network device, wherein the capability information indicates a modulation and coding scheme (MCS) index value supported by the communication apparatus on one or more frequency bands, and the MCS index value comprises some or all MCS index values in one or more MCS index tables.

25. A non-transitory computer-readable storage medium having stored thereon a computer program instruction that, when executed by a processor, implements a step of the method according to claim 1.

26. A communication apparatus, comprising:
a processor; and
a memory configured to store instructions executable by the processor,
wherein the processor is configured to execute the instructions to cause the communication apparatus to perform the method according to claim 11.

27. A non-transitory computer-readable storage medium having stored thereon a computer program instruction that, when executed by a processor, implements the method according to claim 11.
